(19) United States
(12) Patent Application Publication
(10) Pub. No.: US 2019/0162343 A1
(43) Pub. Date: May 30, 2019

(54) Pipeline Connecting Device for Quick Installation and Disassembly and Self-Locking and Self-Sealing

(71) Applicant: GP Enterprises Co., Ltd, Suzhou, Jiangsu (CN)

(72) Inventor: Xian Wang, Suzhou, Jiangsu (CN)

(73) Assignee: GP Enterprises Co., Ltd, Suzhou, Jiangsu (CN)

(21) Appl. No.: 16/066,298

(22) PCT Filed: Jun. 22, 2017
(86) PCT No.: PCT/CN2017/089651

§ 371 Date: Jun. 26, 2018

(30) Foreign Application Priority Data
Jun. 14, 2017 (CN) 201710448076.4

(51) Int. Cl. F16L 37/091

(52) U.S. Cl. CPC F16L 37/091

(57) ABSTRACT

The invention discloses a pipeline connecting device for rapid installation and disassembly and self-locking and self-sealing, which is used for the connection of water pipes, including a thread compression sealing mechanism and a metal circlip self-locking and disassembling mechanism, said metal circlip self-locking and disassembling mechanism includes a metal circlip. The thread compression sealing mechanism includes a threaded base, a threaded upper cap and a sealing ring. The water pipe extends into the threaded base through a threaded upper cap. With the aforementioned structure, the pipeline connecting device for rapid installation and disassembly and self-locking self-sealing according of the present invention, the threaded base is installed at the outlet of the water pump, and the quick installation and disassembly of the water pipe are achieved, and the self-locking and self-sealing effects are achieved at the same time.

### FIELD OF THE INVENTION

The invention relates to the field of water pumps, and more particularly, to a pipeline connecting device that is quick-installed and disassembled and is self-locking and self-sealing.

### BACKGROUND OF THE INVENTION

Presently, there are two main ways for the connection between the pump outlet and the pipeline: one way is thread connection, thread disposed on water pipes, or, water pipe connected to the pump via a conversion joint, and another way is a hose clamping type connection, in which the pump outlet connected to the water pipe via a soft rubber hose, then holding the end of the soft rubber hose by a hose clamp.

The above two connection ways require a certain amount of time for installation and disassembly, and also require tools such as pipe wrenches or screwdrivers for assembling and disassembling, and the sealing performance cannot be ensured, and the longer the usage time, the more troublesome on disassembly.

### SUMMARY OF THE INVENTION

The technical problem to be solved by the present invention is to provide a pipeline connecting device that is quickly installed and disassembled and self-locking and self-sealing, and realizes quick installation of a water pipe and flexible disassembly after long-term use, and ensures the effect of connection locking and waterproof sealing.

To solve the above technical problems, a technical solution adopted by the present invention is to provide a pipeline connecting device for quick installation and disassembly and self-locking and self-sealing, used for connecting water pipes, it comprises: a thread compression sealing mechanism and a metal circlip self-locking and disassembling mechanism, and said metal circlip self-locking and disassembling mechanism includes a metal circlip, said thread compression sealing mechanism includes a threaded base, a threaded upper cap and a sealing ring, said threaded upper cap is disposed in said threaded base, said sealing ring surrounded on the water pipe and located between said threaded upper cap and said threaded base, said metal circlip is disposed under said sealing ring, the inner periphery of said metal circlip is provided with tooth-shaped clips, and said metal circlip provided with a breaking gap instead of a closed annular structure.

In a preferred embodiment of the present invention, said anti-slip wresting ribs are arranged on the exterior periphery of said threaded upper cap.

In a preferred embodiment of the present invention, said arcuate tooth-shaped slices which are obliquely directed downwards.

In a preferred embodiment of the present invention, a first step hole corresponding to the sealing ring is disposed in the threaded base.

In a preferred embodiment of the present invention, said sealing ring and the metal circlip are located in the first step hole, when said threaded upper cap is screwed downwards, the sealing ring is downwards pressed tight by said threaded upper cap, seals the outer wall of the water pipe via compressing the sealing ring, meanwhile, the sealing ring passes torque to said metal circlip, making the breaking gap on the metal circlip more narrow, using the clips to tighten inwards and catch the water pipe, thus self-locking.

In a preferred embodiment of the present invention, wherein when said threaded upper cap is disassembled, the compression deformation of the sealing ring is eliminated, said breaking gap of the metal circlip is restored, and the water pipe is released.

In a preferred embodiment of the present invention, wherein said threaded base is provided with a second step hole corresponding to the water pipe, and the second step hole is concentrically arranged below the first step hole.

In a preferred embodiment of the present invention, said inner hole of the threaded base disposed with female thread, and male thread corresponding to said female thread is provided on the exterior periphery of the threaded upper cover.

In a preferred embodiment of the present invention, the top of said upper screw cap is provided with a guiding through-hole which is corresponding to the water pipe.

In a preferred embodiment of the present invention, a polygonal shaped anti-rotation ring is arranged on the exterior periphery of the thread base.

The beneficial effects of the present invention are as follows: a pipeline connecting device for rapid installation and disassembly and self-locking self-sealing is supplied in the present invention, a threaded base is installed at the outlet of the water pump, and quick installation and disassembly of the water pipe are realized, normally without the need of tools. Can be operated by hands, at the same time achieved the effect of self-locking and self-sealing, the operation is flexible.

### BRIEF DESCRIPTION OF THE FIGURES

In order to more clearly illustrate the technical solutions in the embodiments of the present invention, the drawings used in the description of the embodiments will be briefly described below. Obviously, the drawings in the following description are merely some embodiments of the present invention. For those who skilled in the art, other drawings may also be obtained based on these drawings without paying any creative work. Therein:

FIG. 1 is a schematic structural view of a preferred embodiment of a pipeline connecting device for rapid installation and disassembly and self-locking self-sealing according to the present invention.

FIG. 2 is an exploded view of FIG. 1.

FIG. 3 is a schematic structural view of the metal circlip in FIG. 1.

### DETAILED DESCRIPTION

The following is clearly and completely describes of the technical solutions in the embodiments of the present invention. Apparently, the described embodiments are merely some but not all embodiments of the present invention. All other embodiments obtained by a person who is skilled in the art based on the embodiments of the present invention without creative efforts shall fall within the protection scope of the present invention.

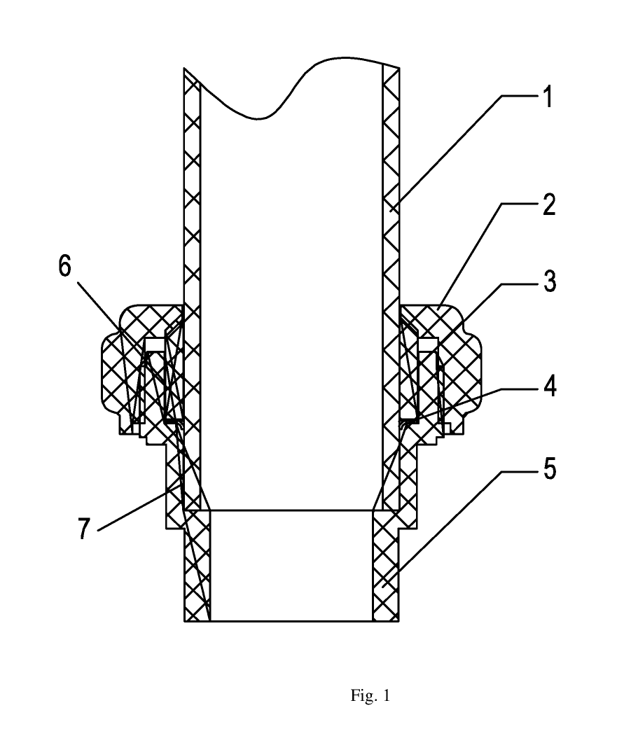

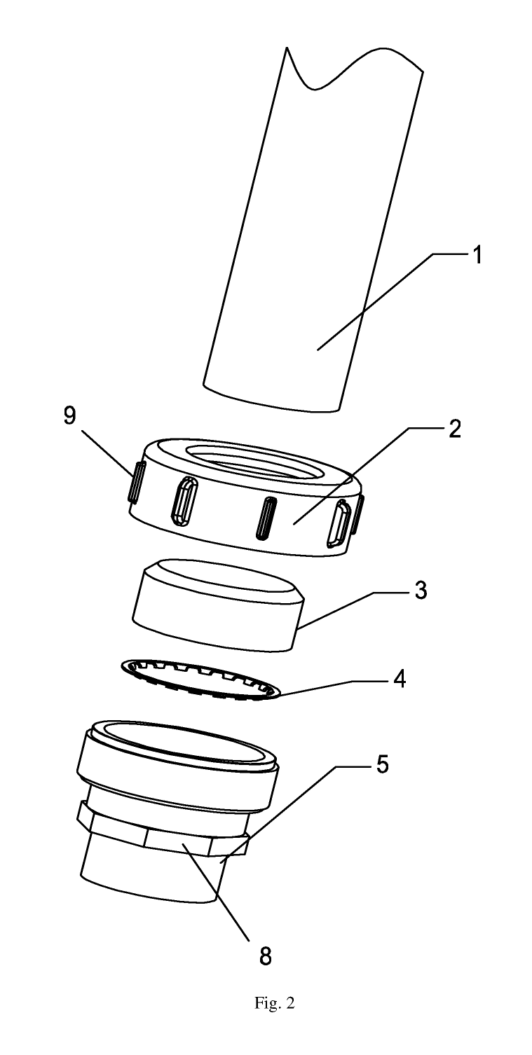

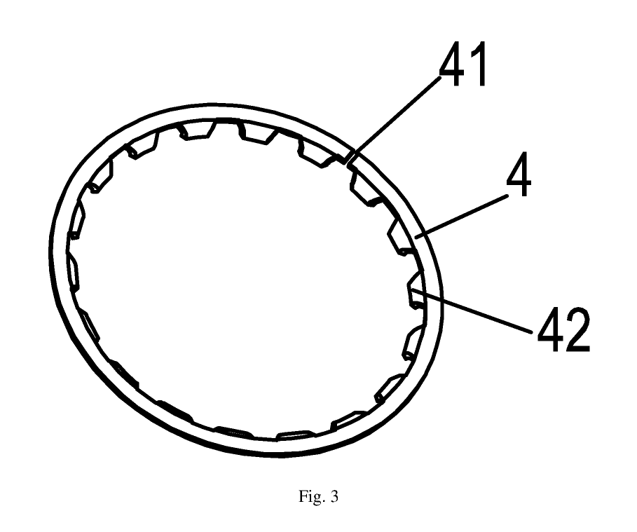

Please refer to FIGS. 1-3, embodiments of the present invention are set out as the following:

A pipeline connecting device for rapid installation and disassembly and self-locking and self-sealing includes: a screw compression sealing mechanism, a metal circlip self-locking and disassembling mechanism, and the metal circlip self-locking and disassembling mechanism comprises a metal circlip 4. The screw compression sealing mechanism includes a threaded base 5, a threaded upper cap 2 and a sealing ring 3, the threaded upper cap 2 is disposed on the threaded base 5, the internal hole of the threaded base 5 is provided with female thread. The exterior periphery of the threaded upper cap 2 is provided with male thread which is corresponding to the female thread, and connection achieved by rotation, the operation is labor-saving, and the waterproof seal function is good.

The water pipe 1 passing through the threaded upper cap 2 then extends into the threaded base 5, and the sealing ring 3 is surrounded disposed on the water pipe 1 and is located between the threaded base 5 and the threaded upper cap 2. The threaded base 5 is disposed at the water pump outlet, and when the water pipe 1 connecting and installing, the sealing ring 3 is pressed downwards by the upper screw cap 2 when it is screwed downwards, and the outer wall of the water pipe 1 is sealed by the compression of the sealing ring 3.

The metal circlip 4 is located under the sealing ring 3. The inner circle of the metal circlip 4 is provided with tooth-shaped blocks 42. The tooth-shaped blocks 42 are arcuate tooth-shaped slices which are obliquely directed downwards, adopting a stainless steel integral structure and having good durability.

The metal circlip 4 is provided with a breaking gap 41 instead of being a closed annular structure. When the threaded upper cap 2 is screwed downwards, the metal circlip 4 is pressed downwards by the sealing ring 3, and at the same time, the sealing ring 3 transmits part of the torque to the metal circlip 4 so that the breaking gap shrank and being more narrow, and the tooth-shaped blocks 42 are tightened inwards to lock the water pipe 1 so as to be self-locked.

Anti-slip wresting ribs 9 are arranged on the exterior periphery of the screw upper cap 2, and a polygonal anti-rotation ring 8 is arranged on the exterior periphery of the screw base 5. The structure facilitates unarmed operation and normally requires no tools for installation and disassembly. The operation is flexible and labor saving.

The threaded base 5 is provided with a first stepped hole 6 corresponding to the sealing ring 3, the sealing ring 3 and the metal circlip 4 are located in the first stepped hole 6, the position limitation effect is good, and when the threaded upper cap 2 is disassembled, the compressing deformation of the sealing ring 3 is eliminated, and the expanding of the breaking gap of the metal circlip 4 is restored and the water pipe is released.

The threaded base 5 is provided with a second step hole 7 corresponding to the water pipe 1, and the second step hole 7 is concentrically arranged below the first step hole 6. The second step hole 7 ensures the passage of the water flow, and can supply position limitation to the end of the water pipe 1, the structure is more stable.

The top of the thread cover 2 is provided with a guiding through-hole which guides the water pipe 1 during installation thereby improved the convenience of installation.

In summary, the invention relates to a pipeline connecting device for rapid installation and disassembly and self-locking and self-sealing, which is installed at the outlet of a water pump to facilitate the installation and disassembly of water pipe, without tools, and the operation is more convenient and the self-locking effect is stable, the loosening of the water pipe is avoid, waterproof seal effect is good, durable.

The foregoing descriptions are merely embodiments of the present invention, and therefore do not mean to limit the scope of the present invention. Any implementation on the content of the present specification by using an alternative structure or equivalent process transformation or direct or indirect application in the same field or in other related technical fields are in the protection scope of the present invention.

1. A pipeline connecting device for quick installation and disassembly and self-locking and self-sealing, used for connecting water pipes, comprising: a thread compression sealing mechanism and a metal circlip self-locking and disassembling mechanism, and said metal circlip self-locking and disassembling mechanism includes a metal circlip, said thread compression sealing mechanism includes a threaded base, a threaded upper cap and a sealing ring, said threaded upper cap is disposed in said threaded base, said sealing ring surrounded on the water pipe and located between said threaded upper cap and said threaded base, said metal circlip is disposed under said sealing ring, the inner periphery of said metal circlip is provided with tooth-shaped clips, and said metal circlip provided with a breaking gap instead of a closed annular structure.

2. The pipeline connecting device for quick installation and disassembly and self-locking and self-sealing according to claim 1, characterized in that anti-slip wresting ribs are arranged on the exterior cylindrical surface of said threaded upper cap.

3. The pipeline connecting device for quick installation and disassembly and self-locking and self-sealing according to claim 1, characterized in that said tooth-shaped slips ribs are arcuate tooth-shaped slices which are obliquely directed downwards.

4. The pipeline connecting device for quick installation and disassembly and self-locking and self-sealing according to claim 1, characterized in that a first step hole corresponding to the sealing ring is disposed in the threaded base.

5. The pipeline connecting device for quick installation and disassembly and self-locking and self-sealing according to claim 4, characterized in that said sealing ring and said metal circlip are located in said first step hole, during the assembling process, when said threaded upper cap is screwed down, the sealing ring is pressed downwards tightly by said threaded upper cap, the outer wall of the water pipe being sealed via compressing the sealing ring, meanwhile, the sealing ring passes torque to said metal circlip, making the breaking gap on the metal circlip smaller, using said tooth-shaped clips to tighten inwards and catch the water pipe, thus said pipeline connecting device is self-locked.

6. The pipeline connecting device for quick installation and disassembly and self-locking and self-sealing according to claim 5, characterized in that when said threaded upper cap is disassembled, the rotation deformation of the sealing ring is eliminated, said breaking gap of the metal circlip is restored, and the water pipe is released.

7. The pipeline connecting device for quick installation and disassembly and self-locking and self-sealing according to claim 4, characterized in that said threaded base is provided with a second step hole corresponding to the water pipe, and the second step hole is concentrically arranged below the first step hole.

8. The pipeline connecting device for quick installation and disassembly and self-locking and self-sealing according to claim 1, characterized in that exterior periphery of said threaded base disposed with male thread, and female thread which is accord to said male thread is correspondingly provided on the and inner hole of said threaded upper cap.

9. The pipeline connecting device for quick installation and disassembly and self-locking and self-sealing according to claim 1, characterized in that the top of said upper screw cover is provided with a guiding through-hole which is corresponding to the water pipe.

10. The pipeline connecting device for quick installation and disassembly and self-locking and self-sealing according to claim 1, characterized in that a polygonal shaped anti-rotation ring is arranged on the exterior periphery of the thread base.
